(19) United States
(12) Patent Application Publication
(10) Pub. No.: US 2004/0187523 A1
(43) Pub. Date: Sep. 30, 2004

(54) Score bar instrumented with a force sensor

(75) Inventor: Judy K. Cox, Corning, NY (US)

Correspondence Address: CORNING INCORPORATED, SP-TI-3-1, CORNING, NY, 14831

(73) Assignee: Corning Incorporated

(21) Appl. No.: 10/395,539

(22) Filed: Mar. 24, 2003

(51) Int. Cl. C03B 33/037

(52) U.S. Cl. 65/158; 65/160; 65/29.11; 65/174

(57) ABSTRACT

A score bar and a system and method for using the score bar to score a glass plate are described herein. Basically, the score bar includes a score wheel and a force sensor (e.g., one-axis force sensor, three-axis force sensor) that enables the measurement of force data between the score wheel and a glass plate while the score wheel is being drawn across the glass plate. A computer collects the measured force data and then analyzes the collected force data to identify and predict when there is a problem with the scoring of the glass plate. For instance, the computer can analyze the collected force data and identify a problem associated with the application of the score bar to the glass plate which could help prevent the unnecessary breakage or chipping of glass plates.

### BACKGROUND OF THE INVENTION

1. Field of the Invention

The present invention relates to a score bar that uses a force sensor in a manner which enables force data to be collected from at least one axis of a force sensor while a score wheel extending from the score bar is being drawn across a piece of glass.

2. Description of Related Art

A score bar which includes a score wheel is used in industry to score a glass plate so that the scored glass plate can be easily broken into a desired shape. To score the glass plate, a score bar holder is used to draw the score bar and in particular the score wheel across the glass plate under a predetermined scoring force so as to create a flaw in the glass plate. The presence of this flaw enables the glass plate to be easily broken into the desired shape. Unfortunately, the traditional score bar and score bar holder used in industry today do not have instrumentation associated with them that enables the measurement of the scoring force between the score wheel and glass plate. However, people have in the past hand placed a button-type force sensor between a non-moving score bar and the glass plate and then measured the normal force between the non-moving score wheel and glass plate. As can be readily appreciated, the hand placement of the force sensor between the non-moving score bar and glass plate enables the scoring force to be measured only in a static position. Thus, it is not possible in industry today to predict or identify when there is an issue during the actual scoring of the glass plate because it is not possible to measure the scoring force while the score bar is in a dynamic position and being drawn across the glass plate. Accordingly, there is a need for a score bar that uses a force sensor in a manner which enables the measurement and collection of scoring forces while the score bar is being drawn across the glass plate. This need and other needs are satisfied by the score bar, system and method of the present invention.

### BRIEF DESCRIPTION OF THE INVENTION

The present invention includes a score bar and a system and method for using the score bar to score a glass plate. Basically, the score bar includes a score wheel and a force sensor (e.g., one-axis force sensor, three-axis force sensor) that enables the measurement of force data between the score wheel and a glass plate while the score wheel is being drawn across the glass plate. A computer collects the measured force data and then analyzes the collected force data to identify and predict when there is a problem with the scoring of the glass plate. For instance, the computer can analyze the collected force data and identify a problem associated with the application of the score bar to the glass plate which could help prevent the unnecessary breakage or chipping of glass plates.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram illustrating the basic components of a system that includes a score bar used to score a glass plate in accordance with the present invention;

FIG. 2 is an exploded perspective view of the score bar shown in FIG. 1;

FIG. 3A is a perspective view of the score bar shown in FIG. 1;

FIG. 3B is a cross-sectional side view of the score bar shown in FIG. 1;

FIG. 4 is a flowchart illustrating the steps of a preferred method for using a score bar to score a glass plate in accordance with the present invention;

FIG. 5 is a diagram illustrating one application in which the score bar of the present invention was used to score a continuous sheet of glass which was then broken into a series of glass plates and then the score bar was used to help remove the side edges of those glass plates;

FIG. 6 is a graph illustrating the measured forces in one application in which the score bar of the present invention was used to horizontally score a continuous sheet of glass; and

FIG. 7 is a graph illustrating the measured forces in one application in which the score bar of the present invention was used to vertically score two sides of a glass sheet.

### DETAILED DESCRIPTION OF THE DRAWINGS

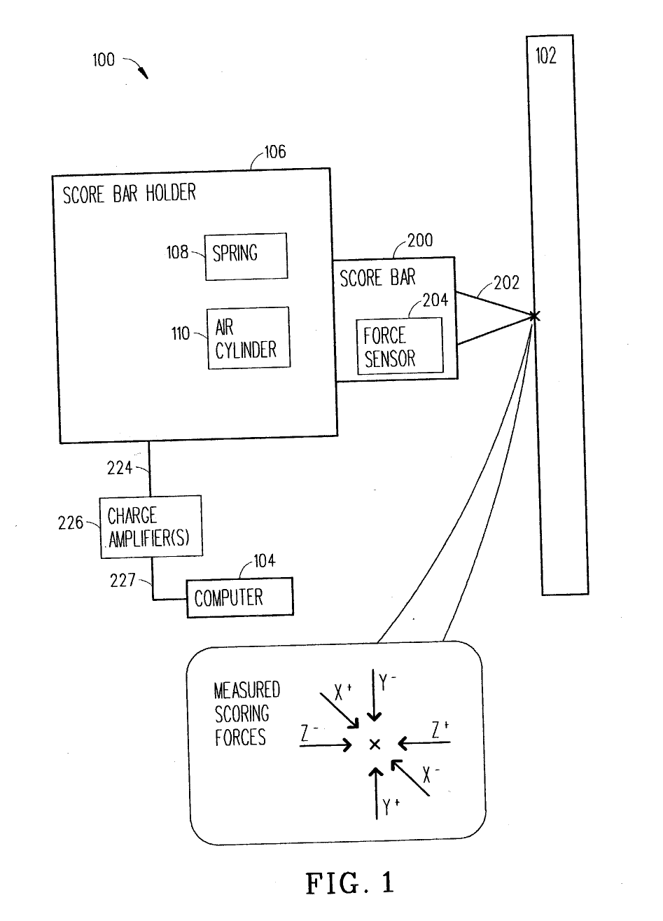

Referring to FIGS. 1-7, there are disclosed a score bar 200 and a system 100 and method 400 for using the score bar 200 to score a glass plate 102 in accordance with the present invention. Although the score bar 200 is described herein as being used to score a glass plate 102, it should be understood that the score bar 200 can also be used to score other types of materials such as plexi-glass™ and mirrors. Accordingly, the system 100, score bar 200 and method 400 of the present invention should not be construed in a limited manner.

Referring to FIG. 1, there is a block diagram illustrating the basic components of the system 100 that includes the score bar 200 which is used to score a glass plate 102. The glass plate 102 in the preferred embodiment is a Liquid Crystal Display (LCD) glass plate 102 that was made in accordance with a fusion process described in U.S. Pat. Nos. 3,338,696 and 3,682,609 both of which are incorporated by reference herein. These LCD glass plates 102 are known in the industry as Corning Incorporated Codes 7059 and 1737 sheet glass or EAGLE 2000™ sheet glass.

The system 100 includes a computer 104 and a score bar holder 106. The score bar holder 106 holds the score bar 200 and applies the score bar 200 and in particular a score wheel 202 extending therefrom onto the glass plate 102. The score bar holder 106 then draws the score wheel 202 across the glass plate 102 so as to score the glass plate 102 (see “x” in FIG. 1). In the preferred embodiment, the score bar holder 106 uses a spring 108 or some other device to push the score bar 200 and score wheel 202 onto the glass plate 102. The score bar holder 106 would then move in a predetermined direction (e.g., horizontal direction, vertical direction) and draw the score wheel 202 across the glass plate 102 to create a flaw or shallow crack of about 30 μm-130 μm deep in the glass plate 102. After the score wheel 202 is drawn across the glass plate 102, the score bar holder 106 uses an air cylinder 110 or some other device to move the score bar 200 and score wheel 202 away from the glass plate 102. The scored glass plate 102 is then broken in a clean manner along the flaw that was made when the score wheel 202 was drawn across the glass plate 102. A robot or some other device can be used to break the scored glass plate 102.

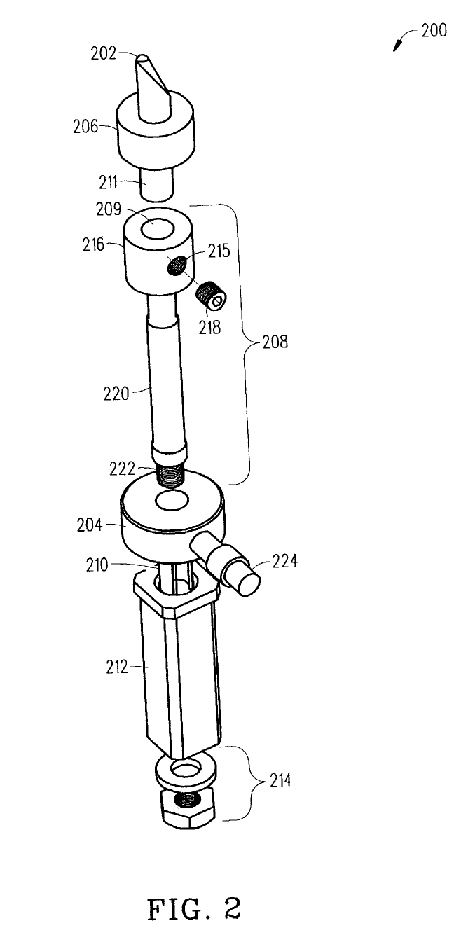

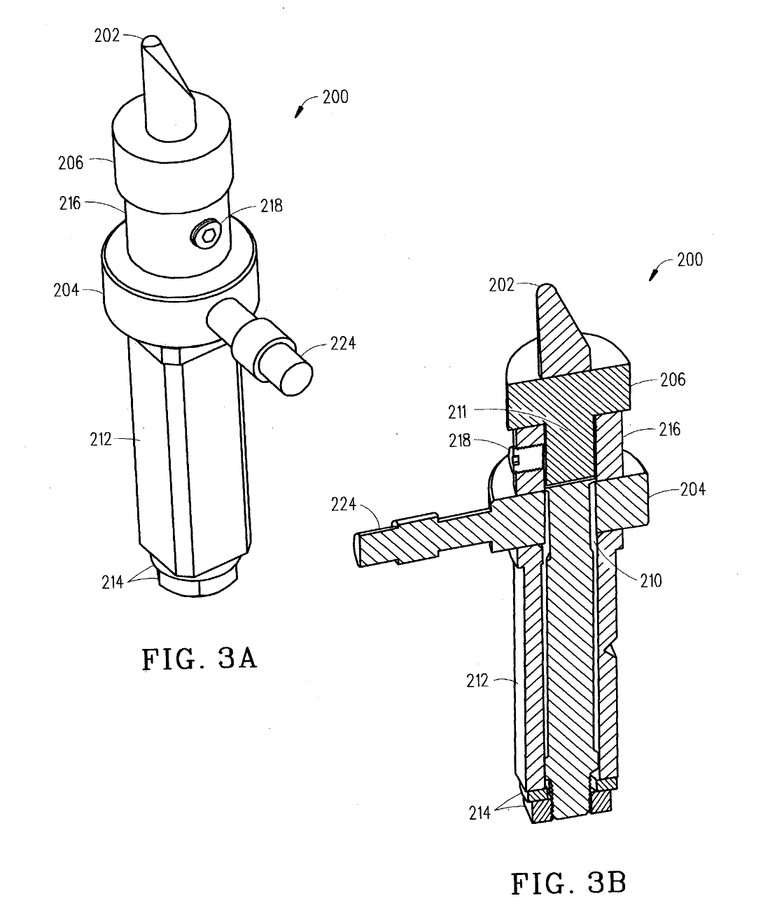

As described above, it is desirable to be able to predict or identify when there is an issue with the score bar 200, the score wheel 202, the score bar holder 106 or any other mechanism associated with the scoring of the glass plate 102 that can lead to problems. To address this need, the score bar 200 incorporates or at least interfaces with a force sensor 204 (e.g., load cell) in a manner which enables the computer 104 to collect the scoring force measurements between the score wheel 202 and the glass plate 102 while the score wheel 202 is being drawn across the glass plate 102. The computer 104 analyzes the collected scoring force data and then predicts or identifies problems associated with the scoring of the glass plate 102. This is a marked improvement over the traditional score bar which did not incorporate or interface with a force sensor in a manner that would enable a computer to collect scoring force data while the score bar was being drawn across the glass plate. A detailed description about the preferred embodiment of the score bar 200 and force sensor 204 is provided below with respect to FIGS. 2-3.

Referring to FIGS. 2-3, there are illustrated several different views of the preferred embodiment of the score bar 200. The score bar 200 includes a caster 206, a bolt 208, a pair of sleeves 210 and 212 and a fastener 214 in addition to the aforementioned score wheel 202 and force sensor 204. The caster 206 holds the score wheel 202. The bolt 208 includes a bolt head 216 at one end of which there is a hole 209 sized to receive an end 211 of the caster 206. The bolt head 216 includes another hole 215 on its side which is sized to receive a set screw 218 (for example) that is used to secure the caster 206 to the bolt head 216 (see FIGS. 3A and 3B). The force sensor 204 has a hole located therein that is sized to slide over a shaft 220 extending from a second end of the bolt head 216. Sleeve 210 (e.g., delrin sleeve 210) is located between an inner diameter of the force sensor 204 and an outer diameter of the shaft 220. As can be seen, the sleeve 210 does not extend very far out if at all from either side of the force sensor 204. Sleeve 212 has a hole located therein that is sized to slide over the outer diameter of the shaft 220 that extends from the force sensor 204. The fastener 214 (e.g., washer and nut 214) interfaces with an end 222 of the shaft 220 that protrudes from sleeve 212 and functions to secure and hold the sleeve 212 next to the force sensor 204 which is held next to the bolt head 216. The bolt 208 and fastener 214 in addition to holding together the components that make-up the score bar 200 also function to pre-load the force sensor 204 at a predetermined load.

Referring also to FIG. 1, the force sensor 204 has a cable 224 which is connected to one or more charge amplifiers 226 which in turn are connected by cable 227 to the computer 104. The computer 104, force sensor 204 and the charge amplifiers 226 together enable the collection of force data between at least one axis of the force sensor 204 and the glass plate 102 while the score wheel 202 is being drawn across the glass plate 102. The computer 104 analyzes the collected force data and then predicts or identifies problems associated with the scoring of the glass plate 102. Depending on the application, the force sensor 204 may be a multi-axis force sensor 204 such as an one-axis force sensor 204 or a three-axis force sensor 204.

If the force sensor 204 is a one-axis force sensor 204, then there is one type of force data that can be measured and collected between the force sensor 204 and the glass plate 102. In particular, the one-axis force sensor 204 can be used to collect:

A normal force which is measured along a Z axis of the force sensor 204 with respect to the glass plate 102. In this case, the force on the force sensor 204 that is measured along the Z axis is positive when the score bar 200 is applied to the glass plate 102 (see FIG. 1).

If the force sensor 204 is a three-axis force sensor 204, then there are three different types of force data that can be measured and collected between the score wheel 202 and the glass plate 102. In particular, the three-axis force sensor 204 can be used to collect:

A normal force which is measured along a Z axis of the force sensor 204 with respect to the glass plate 102. In this case, the force on the force sensor 204 that is measured along the Z axis is positive when the score wheel 202 is applied to the glass plate 102 (see FIG. 1).

A rolling friction force which is measured along a Y axis of the force sensor 204 with respect to the glass plate 102. In this case, the force on the force sensor 204 that is measured along the Y axis is positive when the score wheel 202 is drawn down the glass plate 102 (see FIG. 1).

A force is measured along an X axis of the force sensor 204 with respect to the glass plate 102.

This force is in the same plane but is perpendicular to the rolling friction force (see FIG. 1)★. ★It should be understood that the orientation of the X axis and Y axis are dependent on how the force sensor 204 is assembled within the score bar 200. For instance, the force sensor 204 could be rotated 90° and then the X axis and the Y axis would be switched.

The force sensor 204 in the preferred embodiment is a three-axis piezoelectric force sensor 204 but other types of force sensors can be used such as a strain-gauge force sensor 204 or a single-axis piezoelectric force sensor 204. The preferred three-axis piezoelectric force sensor 204 is manufactured and sold as sensor types. 9017A and 9018A by Kistler Instrument Corp. The Kistler three-axis piezoelectric force sensor 204 has a housing that contains three crystal rings which are mounted between two steel plates. Two of the crystal rings are sensitive to shear and as such are used to measure the forces associated with the X axis and the Y axis. And, one pair of the crystal rings are sensitive to pressure and as such are used to measure the force associated with the Z axis. Each crystal ring is made from a piezoelectric material such as quartz or silicon dioxide. In operation, when the force sensor 204 is loaded with three different forces along the three different axes between the score wheel 202 and the glass plate 102 then the force sensor 204 outputs three different electric charges Qs to three different charge amplifiers 226. Each charge amplifier 226 functions to convert one of the electric charges Qs into a voltage which is directly proportional to one of the forces all of which are then analyzed by the computer 104. An example of the types and magnitudes of forces that can be measured and analyzed by the computer 104 in a couple of specific applications is provided below with respect to FIGS. 5-7.

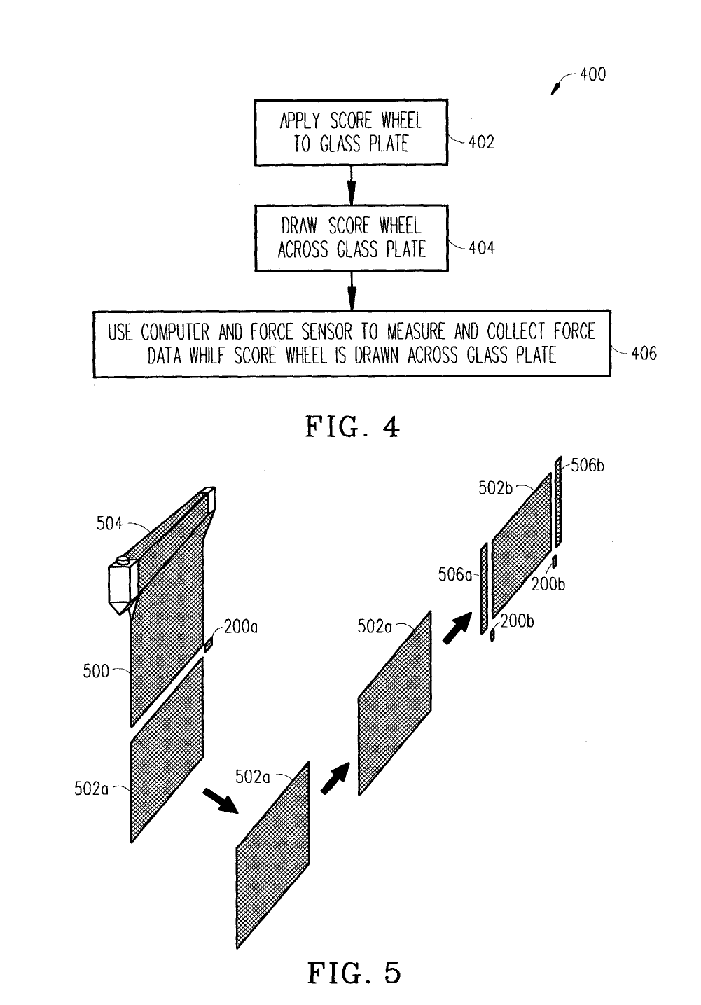

Referring to FIG. 4, there is a flowchart illustrating the steps of the preferred method 400 for using the score bar 200 to score the glass plate 102. The score bar holder 106 which holds the score bar 200 applies (step 402) the score bar 200 and in particular the score wheel 202 onto the glass plate 102. Again, the score bar holder 106 can use a spring 108 or some other device to push or apply the score bar 200 and score wheel 202 onto the glass plate 102. The score bar holder 106 would then move in a predetermined direction (e.g., horizontal direction, vertical direction) and draw (step 404) the score wheel 202 across the glass plate 102. At the same time the score wheel 202 is drawn across the glass plate 102, the computer 104 interfaces with the force sensor 204 (e.g., one-axis force sensor 204, three-axis force sensor 204) through the charge amplifiers 226 and collects (step 406) the force data between the score wheel 202 and the glass plate 102. The computer 104 then analyzes (step 408) the collected force data and predicts or identifies any problems with the scoring of the glass plate. For instance, the computer can analyze the collected force data and identify a problem associated with the application of the score bar to the glass plate which could help prevent the unnecessary breakage or chipping of glass plates.

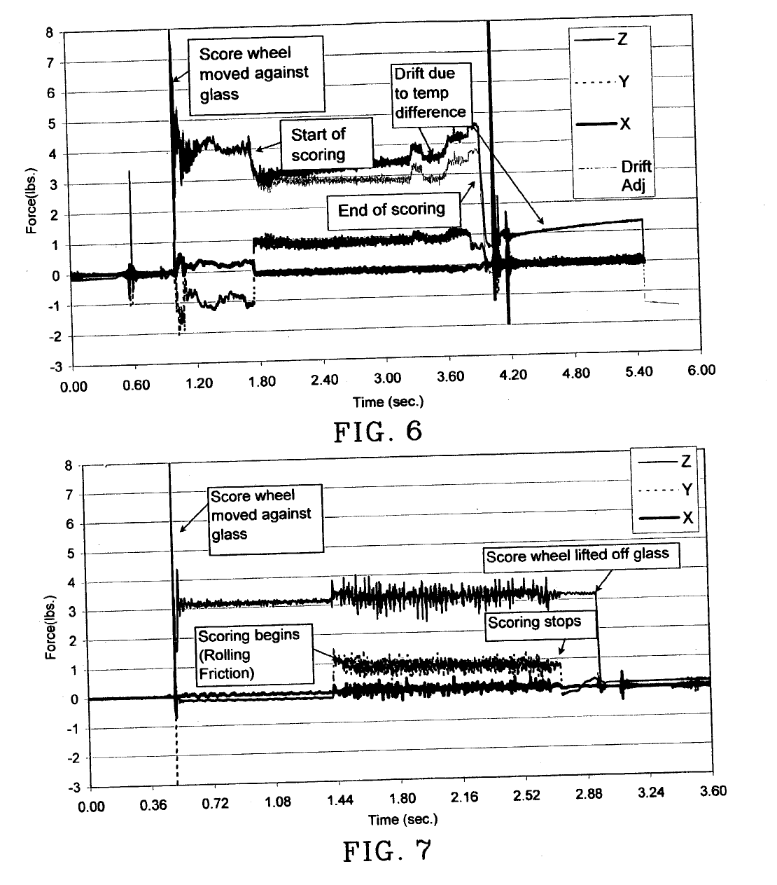

Referring to FIG. 5, there is a diagram illustrating one application in which two score bars 200a and 200b were used to score glass 500 which is eventually broken into glass plate 502b. In this example, a glass tank 504 is used to generate a continuous sheet of glass 500 that can be made in accordance with the fusion process described in the aforementioned U.S. Pat. Nos. 3,338,696 and 3,682,609. The first score bar 200a is used to score in a horizontal direction the continuous sheet of glass 500 which is then broken into a series of glass plates 502a (see FIG. 6 which is not related to TABLE 1). The second score bar 200b is then used to score the glass plates 502a along two vertical directions so that the thicker ends 506a and 506b can be removed so as to form glass plates 502b (see FIG. 7 which is not related to TABLE 1).

The two score bars 200a and 200b mentioned above each have a three-axis piezoelectric force sensor 204 incorporated therein which enables a computer 104 to collect the force data from three different axes of the force sensor 204 while the score wheel 202 is drawn across the glass plates 500 and 502a. Table 1 shows the scoring forces that were measured and collected by the computer 104 during several different experiments in which score bar 200b was used to score the glass plate 502a.

TABLE 1

| Total Score Load Summary | | | | | | | | | | | | | | |
|---|---|---|---|---|---|---|---|---|---|---|---|---|---|---|
| | | | spring | | | | | | | | | | | |
| | | | setting | speed | | | Z | Y | X | Z | Y | X | Roll | Y Zero |
| Date | Inlet/comp | caster | mm | in/sec | wheel | meters | Average | Average | Average | Slope | Slope | Slope | Friction | Average |
| 11-Dec | inlet | new | 17 | 30 | 1 | 0 | 3.10213 | −0.1249 | −0.0068 | 0.04111 | −0.0918 | 0.01332 | 0.2631 | −0.3879 |
| 11-Dec | inlet | new | 17 | 30 | 1 | 50 | 3.1419 | −0.2363 | 0.0134 | 0.06467 | −0.003 | 0.01575 | 0.23315 | −0.4694 |
| 11-Dec | inlet | new | 17 | 30 | 1 | 100 | 3.13787 | −0.2721 | 0.01409 | 0.07391 | −0.0161 | 0.01579 | 0.21242 | −0.4846 |
| 11-Dec | inlet | old | 17 | 30 | 2 | 0 | 3.12766 | −0.1938 | −0.0506 | 0.04199 | −0.1054 | 0.02575 | 0.29484 | −0.4886 |
| 11-Dec | inlet | old | 17 | 30 | 2 | 50 | 3.16483 | −0.14 | −0.0133 | 0.06774 | −0.0782 | 0.02225 | 0.35323 | −0.4932 |
| 11-Dec | inlet | old | 17 | 30 | 2 | 100 | 3.17306 | 0.05468 | −0.056 | 0.06365 | −0.1735 | 0.03591 | 0.60259 | −0.5479 |
| 11-Dec | inlet | old | 17 | 30 | 2 | 150 | 3.15764 | 0.21275 | −0.0836 | 0.06324 | −0.2345 | 0.04259 | 0.76671 | −0.554 |
| 11-Dec | inlet | old | 17 | 30 | 2 | 200 | 3.14179 | −0.0809 | −0.0483 | 0.06036 | −0.1118 | 0.03025 | 0.41918 | −0.5001 |
| 11-Dec | inlet | old | 17 | 30 | 2 | 250 | 3.1668 | −0.068 | −0.0601 | 0.05929 | −0.1752 | 0.03939 | 0.43942 | −0.5074 |
| 12-Dec | inlet | new | 17 | 30 | 3 | 0 | 3.11056 | 0.00015 | 0.017 | 0.04136 | 0.00107 | −0.0074 | 0.69496 | −0.6948 |
| 12-Dec | inlet | new | 17 | 30 | 3 | 50 | 3.10473 | 0.16402 | 0.01396 | 0.04843 | 0.10919 | −0.0062 | 0.72415 | −0.5601 |
| 12-Dec | inlet | new | 17 | 30 | 3 | 100 | 3.11056 | 0.00015 | 0.017 | 0.04136 | 0.00107 | −0.0074 | 0.69496 | −0.6948 |
| 12-Dec | inlet | new | 17 | 30 | 3 | 150 | 3.13719 | 0.15 | −0.0035 | 0.04592 | −0.0377 | 0.00185 | 0.71879 | −0.5688 |
| 12-Dec | inlet | new | 17 | 30 | 3 | 200 | 3.12655 | 0.17406 | −0.0009 | 0.05377 | −0.0795 | 0.00726 | 0.7621 | −0.588 |
| 12-Dec | inlet | new | 17 | 30 | 3 | 250 | 3.13242 | 0.16876 | −0.0081 | 0.05509 | −0.0801 | 0.00773 | 0.71262 | −0.5439 |
| 12-Dec | inlet | old | 17 | 30 | 4 | 0 | 3.10758 | −0.0142 | −0.0256 | 0.04819 | −0.0653 | 0.01343 | 0.4753 | −0.4895 |
| 12-Dec | inlet | old | 17 | 30 | 4 | 50 | 3.14482 | 0.2461 | −0.0998 | 0.04091 | −0.1235 | 0.01937 | 0.80267 | −0.5566 |
| 12-Dec | inlet | old | 17 | 30 | 4 | 100 | 3.1374 | 0.44763 | −0.129 | 0.02339 | −0.1174 | 0.01241 | 1.16951 | −0.7219 |
| 12-Dec | inlet | old | 17 | 30 | 4 | 150 | 3.12034 | 0.49698 | −0.12 | 0.02411 | −0.1108 | 0.01322 | 1.17329 | −0.6763 |
| 12-Dec | inlet | old | 17 | 30 | 4 | 200 | 3.12182 | 0.48292 | −0.1059 | 0.01933 | −0.0354 | 0.00841 | 1.16677 | −0.6839 |
| 12-Dec | inlet | old | 17 | 30 | 4 | 250 | 3.08788 | 0.4628 | −0.134 | 0.02081 | −0.0688 | 0.00749 | 1.06836 | −0.6056 |
| 12-Dec | comp | new | 17 | 30 | 5 | 0 | 3.28099 | 0.29284 | 0.05249 | −0.0153 | −0.0864 | −0.0025 | 0.65592 | −0.3631 |
| 12-Dec | comp | new | 17 | 30 | 5 | 50 | 3.31094 | 0.77072 | 0.08105 | −0.0094 | −0.0037 | 0.00138 | 1.13994 | −0.3692 |
| 12-Dec | comp | new | 17 | 30 | 5 | 100 | 3.28673 | 0.71792 | 0.08115 | −0.0221 | 0.0117 | 0.00136 | 1.07721 | −0.3593 |
| 12-Dec | comp | new | 17 | 30 | 5 | 150 | 3.27635 | 0.55694 | 0.07111 | −0.0191 | −0.0054 | 0.00265 | 0.95668 | −0.3997 |
| 12-Dec | comp | new | 17 | 30 | 5 | 200 | 3.28732 | 0.56599 | 0.0709 | −0.0143 | −0.0032 | 0.00326 | 0.95603 | −0.39 |
| 12-Dec | comp | new | 17 | 30 | 5 | 250 | 3.30251 | 0.55489 | 0.0873 | −0.0056 | −0.0163 | 0.00106 | 0.93673 | −0.3818 |
| 13-Dec | comp | old | 17 | 30 | 6 | 0 | 3.25672 | 0.14617 | −0.0489 | −0.0012 | −0.1149 | −0.0026 | 0.68273 | −0.5366 |
| 13-Dec | comp | old | 17 | 30 | 6 | 50 | 3.26656 | 0.38772 | −0.036 | −0.0266 | −0.3295 | 0.00094 | 1.0815 | −0.6938 |
| 13-Dec | comp | old | 17 | 30 | 6 | 100 | 3.28655 | 0.69164 | −0.0171 | −0.0125 | −0.1696 | 0.00361 | 1.34292 | −0.6513 |
| 13-Dec | comp | old | 17 | 30 | 6 | 150 | 3.2628 | 0.79976 | −0.0514 | −0.0088 | −0.1095 | 0.00326 | 1.41146 | −0.6117 |
| 13-Dec | comp | old | 17 | 30 | 6 | 200 | 3.24433 | 0.58342 | −0.0384 | 0.0076 | 0.01431 | −0.001 | 1.19621 | −0.6128 |
| 13-Dec | comp | old | 17 | 30 | 6 | 250 | 3.22796 | 0.63195 | −0.0282 | −0.014 | −0.0893 | 0.00144 | 1.21785 | −0.5859 |
| 13-Dec | comp | new | 17 | 30 | 7 | 0 | 3.225 | 0.26971 | 0.02966 | −0.0024 | −0.0256 | −0.005 | 0.73646 | −0.4667 |
| 13-Dec | comp | new | 17 | 30 | 7 | 50 | 3.23701 | 0.57006 | 0.07 | −0.0189 | −0.1494 | −0.0138 | 0.87385 | −0.3038 |
| 13-Dec | comp | new | 17 | 30 | 7 | 100 | 3.21658 | 0.60972 | 0.06817 | −0.0274 | −0.1657 | −0.0093 | 0.9437 | −0.334 |
| 13-Dec | comp | new | 17 | 30 | 7 | 150 | 3.23257 | 0.63964 | 0.07232 | −0.0189 | −0.1086 | −0.0075 | 0.98647 | −0.3468 |
| 13-Dec | comp | new | 17 | 30 | 7 | 200 | 3.23683 | 0.58985 | 0.06224 | −0.0258 | −0.1184 | −0.0065 | 0.88862 | −0.2988 |
| 13-Dec | comp | new | 17 | 30 | 7 | 250 | 3.22395 | 0.60282 | 0.07014 | −0.0135 | −0.1145 | −0.009 | 0.90041 | −0.2976 |
| 12-Dec | inlet | old | 19.5 | 30 | 4 | 251 | 3.22375 | 0.55536 | −0.1531 | 0.02222 | −0.0979 | 0.01639 | 1.29611 | −0.7408 |
| 12-Dec | inlet | old | 22 | 30 | 4 | 252 | 3.40093 | 0.5984 | −0.1491 | 0.01239 | −0.0233 | 0.00416 | 1.33996 | −0.7416 |
| 12-Dec | inlet | old | 17 | 30 | 4 | 253 | 3.1053 | 0.45863 | −0.1282 | 0.00867 | −0.0855 | 0.00949 | 1.10026 | −0.6416 |
| 12-Dec | inlet | old | 14.5 | 30 | 4 | 254 | 2.94183 | 0.40756 | −0.1215 | 0.01843 | −0.0933 | 0.01471 | 1.02751 | −0.62 |
| 12-Dec | inlet | old | 12 | 30 | 4 | 255 | 2.79394 | 0.40323 | −0.1194 | 0.00987 | −0.0982 | 0.01839 | 1.05621 | −0.653 |
| 12-Dec | inlet | old | 9.5 | 30 | 4 | 256 | 2.63329 | 0.36331 | −0.1126 | 0.024 | −0.0979 | 0.01273 | 1.04064 | −0.6773 |
| 12-Dec | inlet | old | 7 | 30 | 4 | 257 | 2.45764 | 0.31034 | −0.1087 | 0.01241 | −0.0721 | 0.0112 | 0.91795 | −0.6076 |
| 12-Dec | inlet | old | 4.5 | 30 | 4 | 258 | 2.32674 | 0.1937 | −0.097 | 0.02205 | −0.0801 | 0.0113 | 0.75385 | −0.5601 |
| 12-Dec | inlet | old | 2 | 30 | 4 | 259 | 2.15359 | 0.18683 | −0.0981 | 0.03234 | −0.0606 | 0.01184 | 0.72169 | −0.5349 |
| 12-Dec | inlet | old | 0 | 30 | 4 | 260 | 2.0723 | 0.19736 | −0.1053 | 0.02293 | −0.0639 | 0.01008 | 0.74359 | −0.5462 |
| 13-Dec | comp | old | 0 | 30 | 2 | 251 | 1.98432 | 0.43664 | −0.0068 | −0.0722 | −0.0712 | 0.00537 | 0.79077 | −0.3541 |
| 13-Dec | comp | old | 22 | 30 | 2 | 252 | 3.52031 | 0.89644 | −0.022 | −0.0568 | −0.1276 | 0.0034 | 1.35723 | −0.4608 |
| 13-Dec | comp | new | 17 | 20 | 7 | 251 | 3.24564 | 0.64266 | 0.07244 | 0.003 | −0.0544 | 0.00045 | 0.99931 | −0.3566 |
| 13-Dec | comp | pillar | 17 | 30 | 8 | 0 | 3.19176 | −0.0217 | 0.06937 | 0.00208 | −0.0735 | −0.0048 | 0.25243 | −0.2741 |
| | | post | | | | | | | | | | | | |

*The score associated with end 506a is referred to as “inlet” in TABLE 1. And, the score associated with end 506b is referred to as “compression” or “comp” in TABLE 1.

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A score bar which uses a force sensor that enables force data to be collected between at least one axis of the force sensor and a piece of material while a score wheel is drawn across the piece of material.

2. The score bar of claim 1, wherein said piece of material is a glass plate.

3. The score bar of claim 1, wherein said collected force data includes a normal force measured along a Z axis of the force sensor with respect to the piece of material.

4. The score bar of claim 1, wherein said collected force data includes:
a normal force measured along a Z axis of the force sensor with respect to the piece of material;
a rolling friction force measured along a Y axis of the force sensor with respect to the piece of material; and
a force measured along an X axis of the force sensor with respect to the piece of material.

5. The score bar of claim 1, wherein said force sensor is a piezoelectric three-axis force sensor.

6. The score bar of claim 1, wherein a computer analyzes the collected force data and identifies problems associated with the scoring of said piece of material.

7. A score bar, comprising:
a caster incorporating a score wheel;
a bolt including a bolt head at a first end of which there is secured said caster;
a force sensor located around a shaft extending from a second end of the bolt head of said bolt;
a first sleeve located around the shaft of said bolt so as to secure said force sensor adjacent to the bolt head of said bolt; and
a fastener that interfaces with an end of said shaft protruding from said first sleeve so as to secure said first sleeve adjacent to said force sensor which is adjacent to the bolt head of said bolt.

8. The score bar of claim 7, further comprising a second sleeve located between an inner diameter of said force sensor and an outer diameter of the shaft of said bolt.

9. The score bar of claim 7, wherein said force sensor enables force data to be collected between at least one axis of the force sensor and a piece of material while the score wheel is drawn across the piece of material.

10. The score bar of claim 9, wherein said collected force data includes a normal force measured along a Z axis of the force sensor with respect to the piece of material.

11. The score bar of claim 9, wherein said collected force data includes:
a normal force measured along a Z axis of the force sensor with respect to the piece of material;
a rolling friction force measured along a Y axis of the force sensor with respect to the piece of material; and
a force that is measured along an X axis of the score wheel with respect to the piece of material.

12. The score bar of claim 7, wherein said force sensor is a piezoelectric three-axis force sensor.

13. The score bar of claim 7, wherein a computer analyzes the collected force data and identifies problems associated with scoring of the piece of material.

14. The score bar of claim 7, wherein said piece of material is a glass plate.

15. A system, comprising:
a score bar holder that holds a score bar and applies and draws a score wheel of the score bar across a sheet of material; and
a computer that interfaces with a force sensor and at least one charge amplifier associated with the score bar and collects force data associated with at least one axis of the force sensor while the score wheel is drawn across the sheet of material.

16. The system of claim 15, wherein said sheet of material is glass.

17. The system of claim 15, wherein said collected force data includes a normal force measured along a Z axis of the force sensor with respect to the sheet of material.

18. The system of claim 15, wherein said collected force data includes:
a normal force measured along a Z axis of the force sensor with respect to the sheet of material;
a rolling friction force measured along a Y axis of the force sensor with respect to the sheet of material; and
a force that is measured along an X axis of the force sensor with respect to the sheet of material.

19. The system of claim 15, wherein said force sensor is a piezoelectric three-axis force sensor.

20. The system of claim 15, wherein said computer analyzes the collected force data and identifies problems associated with the scoring of the sheet of material.

21. A method for scoring a piece of material, said method comprising the steps of:
applying a score wheel incorporated within a score bar to the piece of material;
drawing the score wheel across the piece of material; and
using a computer and a force sensor and at least one charge amplifier associated with the score bar to collect force data associated with at least one axis of the force sensor while the score wheel is drawn across the piece of material.

22. The method of claim 21, further comprising the step using the computer to analyze the collected force data and predict problems associated with the scoring of the piece of material.

23. The method of claim 21, wherein said computer collects force data which includes a normal force measured along a Z axis of the force sensor with respect to the piece of material.

24. The method of claim 21, wherein said computer collects force data which includes:
a normal force measured along a Z axis of the force sensor with respect to the piece of material;
a rolling friction force measured along a Y axis of the force sensor with respect to the piece of material; and
a force measured along an X axis of the force sensor with respect to the piece of material.

25. The method of claim 21, wherein said force sensor is a piezoelectric three-axis force sensor.

26. The method of claim 21, wherein said piece of material is a glass plate.
